(19) United States
(12) Patent Application Publication
(10) Pub. No.: US 2005/0273209 A1
(43) Pub. Date: Dec. 8, 2005

(54) Device for making available parameters

(75) Inventors: Werner Bernzen, Ehningen (DE); Wilfried Huber, Ostelsheim (DE); Volker Maass, Stuttgart (DE); Avshalom Suissa, Althensgstett (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/507,585

(22) PCT Filed: Mar. 7, 2003
(86) PCT No.: PCT/EP03/02340

§ 371 Date: Aug. 2, 2005

(30) Foreign Application Priority Data
Mar. 13, 2002 (DE) 102 11 220.7

(51) Int. Cl. G06F 19/00

(52) U.S. Cl. 701/1; 701/54; 701/70

(57) ABSTRACT

The device according to the invention relates to a device for making available parameters which are taken into account during the regulation and/or control of a parameter which describes and/or influences the movement of a vehicle. The parameters which are made available are vehicle movement parameters which describe the movement of the vehicle and/or underlying surface parameters which describe the quality and/or the course of the underlying surface. The device according to the invention contains sensing means with which first vehicle movement parameters are sensed, and computing means with which second vehicle movement parameters and/or underlying surface parameters are determined at least as a function of the first vehicle movement parameters. The sensing means and the computing means are spatially combined to form one physical unit. The first vehicle movement parameters and the second vehicle movement parameters and/or underlying surface parameters which are determined with the computing means are made available to processing means, which are arranged outside the physical unit in the vehicle, for further processing.

This application claims the priority of German patent application 102 11 220.7, filed Mar. 13, 2002 (PCT International Application No. PCT/EP03/02340), the disclosure of which is expressly incorporated by reference herein.

### BACKGROUND AND SUMMARY OF THE INVENTION

The invention relates to a device for making available parameters that are used to regulate or control a parameter which describes or influences the movement of a vehicle.

Devices of this type are known from the prior art in a wide variety of modifications. For example, integrated, intelligent sensors are described in various integration stages in the 23^{rd} edition of the book “Kraftfahrtechnisches Taschenbuch [motor vehicle handbook]”, ISBN 3-528-03876-4. The actual sensor and an analog signal conditioning means are combined in a first integration stage, while the actual sensor, an analog signal conditioning means and an analog/digital converter are combined in a second integration stage, and the actual sensor, an analog signal conditioning means, an analog/digital converter and a microcomputer are combined in a third integration stage, in each case to form one sensor module.

German patent document DE 42 28 893 A1 describes a sensor module which is used in a system for influencing the vehicle movement dynamics of a motor vehicle. The sensor module has at least two sensor units for sensing movements of the vehicle. Furthermore, the sensor module has first evaluation units with which the signals of the sensor units are evaluated. The system for influencing the vehicle movement dynamics of a motor vehicle has second evaluation units which are arranged outside the sensor module and which are connected to the first evaluation units by connecting means, and with which the signals which are processed in the first evaluation units, depending on the regulation and/or control objective, to form actuation signals of actuators which influence the movements of the vehicle. The sensor units are acceleration sensors for sensing longitudinal and lateral acceleration, and a rotational velocity sensor for sensing yaw movement of the vehicle. The sensor signals which are determined with the sensor units are corrected in terms of temperature, lateral sensitivity and center of gravity using the first evaluation units. The corrected sensor signals are supplied to the second evaluation units for further processing. The second evaluation units are a vehicle regulating system or vehicle control system, a steering regulating system or steering control system, a brake regulating system or brake control system or a drive regulating system or drive control system.

In the system described in German patent document DE 42 28 893 A1, for influencing the vehicle movement dynamics of a motor vehicle, the corrected sensor signals determined using the sensor module are made available for the various second evaluation means, and are processed therein. This common use of the sensor units which are combined to form the sensor module ensures that the same sensor units do not have to be installed individually (i.e., separately) in the vehicle for each of the second evaluation units. As a result, the number of sensor units which are installed in a vehicle and are in particular identical is significantly reduced.

The signal manipulations which are performed in the sensor module are simple signal manipulations, being essentially corrections of the sensor signals which are determined using the sensor units. More complex signal manipulations, for example the calculation of vehicle movement parameters from the sensor signals which are determined using the sensor units provided in the sensor module is not provided with the sensor module described in DE '893. This type of signal manipulation takes place in each of the second evaluation units independently (i.e., separately) for each respective application purpose. If the same vehicle movement parameter is required in the various second evaluation units, this vehicle movement parameter is therefore calculated independently in each of these evaluation units. The same processing routine has to be made available in each of these second evaluation units, and the more complex signal manipulation unnecessarily has to be carried out repeatedly. This separate execution of the more complex signal manipulation for each of the second evaluation units is disadvantageous.

One object of the invention is to reduce the computational effort that is required to provide parameters which are used to regulate or control a parameter which describes or influences the movement of the vehicle.

This and other objects and advantages are achieved by the device according to the invention, in which sensing means are provided for sensing first vehicle movement parameters. In addition, computing means are provided for determining second vehicle movement parameters and/or underlying surface parameters, at least as a function of the first vehicle movement parameters. The sensing means and the computing means are spatially combined to form a single physical unit. The first vehicle movement parameters, the second vehicle movement parameters and/or underlying surface parameters are made available to processing means, which are arranged outside the physical unit in the vehicle, for further processing.

The device according to the invention forms an independent physical unit. Since the processing means which are arranged in the vehicle are arranged outside the device according to the invention (i.e., physically independently of or spatially separate from the latter), the device according to the invention can be mounted at an advantageous location in the vehicle independently of the processing means which are arranged in the vehicle.

The vehicle movement parameters are parameters which describe the movement of the vehicle. The underlying surface parameters are parameters which describe the quality and/or the course of the underlying surface.

The processing means which are arranged in the vehicle are devices with which a parameter that describes and/or influences the movement of the vehicle is regulated and/or controlled. Examples of such devices are
a yaw rate controller with which the yaw rate of the vehicle (i.e., the rotational movement of the vehicle about is vertical axis) is regulated,
a brake slip controller,
a traction controller,
a device which is used to influence the behavior of the chassis (more precisely damping and/or suspension behavior of the chassis), or
an inter-vehicle distance controller in which the brakes and/or the engine are used to adjust the distance from the vehicle traveling in front,
an engine controller, or
a transmission controller.

Alternatively or in addition, the processing means can also be a component of a device with which a parameter which describes and/or influences the movement of the vehicle is regulated and/or controlled. For example, the input signal processing means can be that of such a device. One of the functions of such an input signal processing means can be, for example, to perform an necessary conditioning of the parameters which are supplied. For example, one such parameter can be transformed in accordance with the predefined values of the regulating and/or controlling process taking place in the device, with respect to a specific location in the vehicle.

With the device according to the invention two concepts are implemented. On the one hand, first vehicle movement parameters (which are sensed using the sensing means arranged in the device according to the invention) are made available to various processing means, for further processing. Consequently, it is no longer necessary to make available the respective corresponding sensing means (i.e., sensors), for each of the processing means which processes these first vehicle movement parameters. As a result, the number of sensors installed in the vehicle is reduced. Most particularly, the installation of identical sensors is avoided.

On the other hand, with the computing means contained in the device according to the invention, second vehicle movement parameters and/or underlying surface parameters are determined at least as a function of the first vehicle movement parameters. These second vehicle movement parameters and/or underlying surface parameters are also made available to various processing means. Consequently, it is no longer necessary for each of these processing means to determine these second vehicle movement parameters and/or underlying surface parameters independently. This central provision of the parameters which are determined or calculated allows the computing effort to be carried out or performed by the respective processing means to be reduced. The central calculation of the second vehicle movement parameters and/or underlying surface parameters can ensure better signal quality. On the one hand, in the computing means which are contained in the device according to the invention it is possible to use a more complex algorithm for calculation than is possible with the processing means since in this case of central provision the computer power of the processing means is not adversely affected. On the other hand, higher quality sensors are used since, by cutting down the number of identical sensors, money can be saved, which can be used for higher quality sensors.

As already stated, in conjunction with the device according to the invention a distinction is made between first and second vehicle movement parameters. The first vehicle movement parameters are those which are sensed using the sensing means contained in the device according to the invention. That is to say such vehicle movement parameters which are sensed directly using a sensor. These are, for example,
lateral acceleration of the vehicle,
longitudinal acceleration of the vehicle,
vertical acceleration of the vehicle,
rotational velocity of the vehicle about its vertical axis,
rotational velocity of the vehicle about its longitudinal axis, and/or
rotation velocity of the vehicle about its lateral axis.

It has proven advantageous with the device according to the invention to select the following basic and minimum configuration with respect to the first vehicle movement parameters, and thus the sensing means which are necessary for them: with the device according to the invention the intention is to sense at least the lateral acceleration of the vehicle, the longitudinal acceleration of the vehicle, the vertical acceleration of the vehicle and the rotational velocity of the vehicle about its vertical axis.

The second vehicle movement parameters are those which are determined (i.e., calculated) by the computing means which are contained in the device according to the invention. Examples are:
the longitudinal velocity of the vehicle, and/or
the lateral velocity of the vehicle.

The underlying surface parameters are also determined (i.e., calculated) by the computing means contained in the device according to the invention. Examples of the underlying surface parameters are:
the gradient and/or the lateral inclination of the underlying surface, which both describe the course of the underlying surface, and/or
the coefficient of friction of the underlying surface, which describes the quality of the underlying surface.

As is apparent, the first and second vehicle movement parameters are different physical parameters.

In the device according to the invention, the second vehicle movement parameters and the underlying surface parameters are not determined directly using a second means.

As already explained, the second vehicle movement parameters and/or the underlying surface parameters are determined at least as a function of the first vehicle movement parameters, as well as wheel speed parameters which describe the wheel speed of the vehicle wheels and/or a parameter which describes the steering wheel angle. As an alternative to the parameter which describes the steering wheel angle, it is also possible to take into account parameters which describe the wheel-specific steering angles of the vehicle wheels. If the wheel-specific steering angles are taken into account instead of the steering wheel angle, the second vehicle movement parameters and/or the underlying surface parameters are determined with greater accuracy.

Further parameters which can be included in the determination of the second vehicle movement parameters and/or the underlying surface parameters are: spring compression travel for the individual vehicle wheels, and/or brake pressure which is set for the individual vehicle wheels. The spring compression travel parameters can be made available by a device which is used to influence the behavior of the chassis. The brake pressure parameters are either measured parameters or estimated parameters.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic view of the basic interaction of the device according to the invention with the various processing means arranged in the vehicle;

FIG. 2 is a schematic view of the interaction of the device according to the invention with a yaw rate controller arranged in the vehicle; and

FIG. 3 is a schematic view of the design of the device according to the invention.

### DETAILED DESCRIPTION OF THE DRAWINGS

As noted previously, the device according to the invention contains, as a physical unit, sensing means on the one hand and computing means, on the other. It is referred to in the following exemplary embodiment as a sensor module as an abbreviated form.

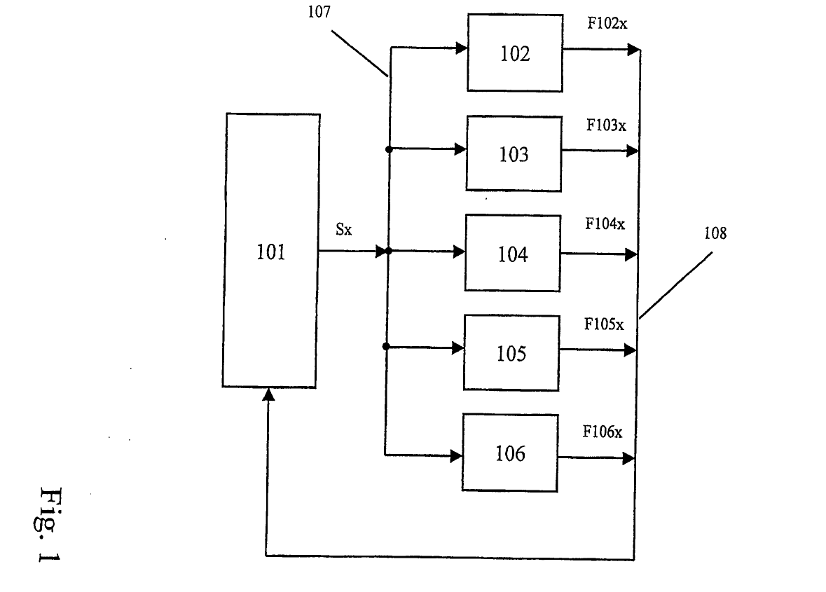

In FIG. 1, block 101 represents the device according to the invention. The sensor module 101 is connected via a data bus 107 (which may be a CAN bus) to blocks 102, 103, 104, 105 and 106 which are processing means arranged in the vehicle. Block 102 represents a yaw rate controller, block 103 represents a device which can be used to influence the behavior of the chassis, block 104 represents an inter-vehicle distance controller, block 105 represents an engine controller and block 106 represents an electronic transmission controller. Both this enumeration and the view selected in FIG. 1 are not intended to be conclusive. Of course, additional or other processing means, for example an anti-slip brake controller or a traction controller, can be arranged in the vehicle in any desired combination. Furthermore, it is also conceivable for only some of the processing means which are enumerated above to be arranged in a vehicle. As is apparent, the processing means which are specified above are ones with which a parameter which describes and/or influences the movement of the vehicle is regulated and/or controlled.

The processing means 102, 103, 104, 105, and 106 are supplied, via the data bus 107, with parameters Sx which are made available by the device according to the invention (i.e., the sensor module), and which are taken into account in the processing means during the regulation and/or control, respectively carried out by them, of a parameter which describes and/or influences the movement of the vehicle. The parameters Sx are vehicle movement parameters which describe the movement of the vehicle and/or underlying surface parameters which describe the quality and/or the course of the underlying surface. The vehicle movement parameters are in turn composed of first vehicle movement parameters, which are sensed with the sensing means contained in the sensor module 101, and the second vehicle movement parameters, which are determined using the computing means contained in the sensor module.

At this point it is to be noted that for the signals Sx, any desired configurations of the first vehicle movement parameters, the second vehicle movement parameters and the underlying surface parameters are conceivable. The signals Sx are usually composed of the first vehicle movement parameters, combined with the second vehicle movement parameters or the underlying surface parameters, or combined with both together. It is also conceivable that the signals Sx will not each have all of the individual signals of the first vehicle movement parameters, of the second vehicle movement parameters or of the underlying surface parameters but rather any respectively desired set thereof.

The processing means 102 generate signals F102x, the processing means 103 generate signals F103x, the processing means 104 generate signals F104x, the processing means 105 generate signals F105x, and the processing means 106 generate signals F106x. These are made available to the sensor module 101 via a data bus 108, which may also be implemented as a CAN bus. The individual signals which are generated by the processing means are, for example, parameters which contain information about whether the respective processing means itself or, if present, which of the subordinate regulators present in the respective processing means is active at that particular time. Alternatively, these are parameters which will represent the working state of the actuators which are actuated by the processing means in order to regulate and/or control a parameter which describes and/or influences the movement of the vehicle. The information which is supplied to the sensor module 101 via the data bus 108 is taken into account during the determination of the parameters Sx.

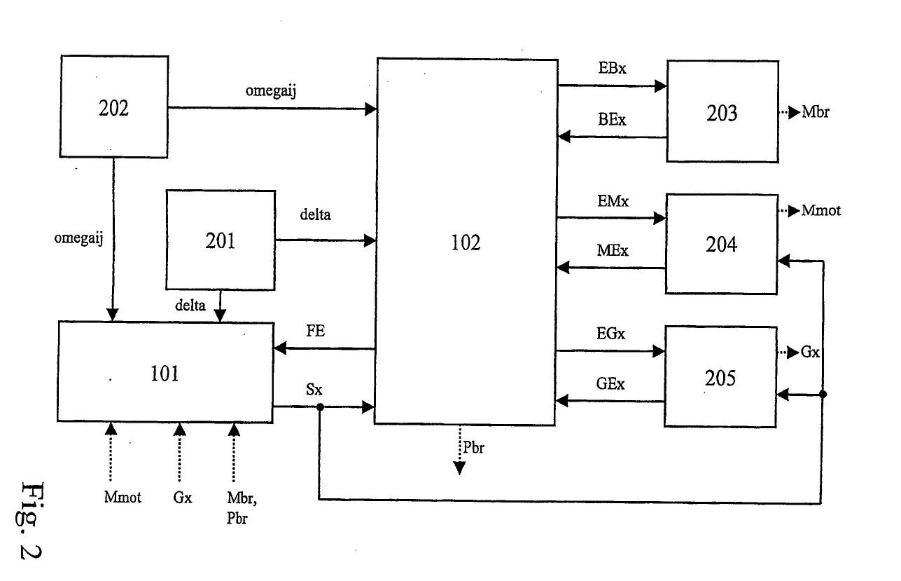

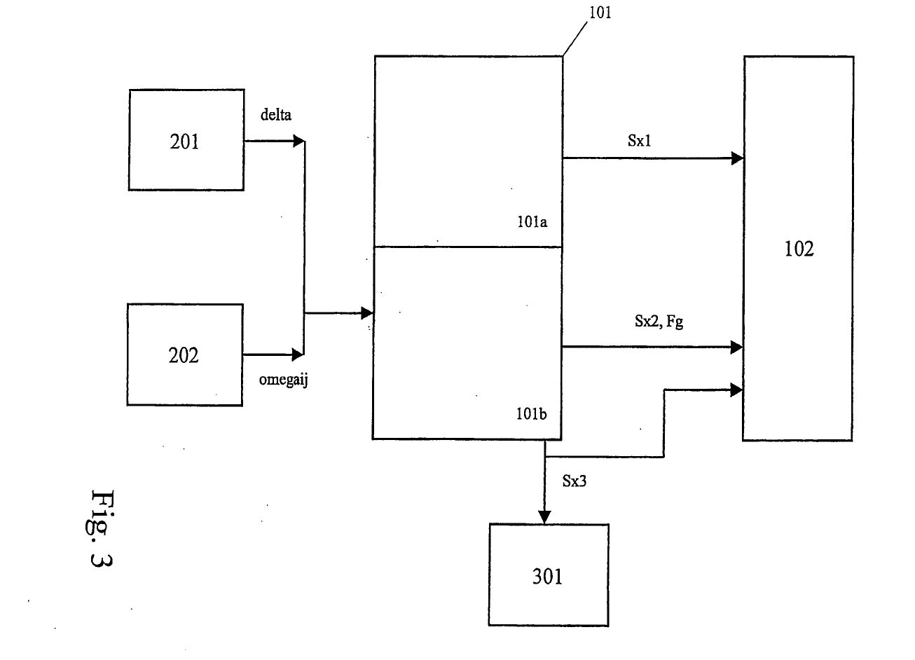

FIG. 1 merely represents the basic interaction of the device according to the invention (i.e., the sensor module), with the processing means arranged in the vehicle. Against this background, the view selected in FIG. 1 does not purport to be complete. Further blocks or components to which the device according to the invention or the processing means are connected can be found in FIGS. 2 and 3.

In FIG. 2, block 101 represents the sensor module. The parameters Sx which are made available by the sensor module are supplied to a processing means 102, which is a yaw rate controller. The parameters Sx are also supplied to blocks 204 and 205 which will be described below.

The parameters Sx comprise vehicle movement parameters and underlying surface parameters. The vehicle movement parameters are composed of first vehicle movement parameters, which are sensed with the sensing means contained in the sensor module, and second vehicle movement parameters, which are determined using the computing means contained in the sensor module. The first vehicle movement parameters are the lateral acceleration of the vehicle, the longitudinal acceleration of the vehicle, the vertical acceleration of the vehicle and the yaw rate of the vehicle. In addition to these parameters, the first vehicle movement parameters can also contain an angular velocity with respect to the longitudinal axis of the vehicle and an angular velocity with respect to the lateral axis of the vehicle. The second vehicle movement parameters are the longitudinal velocity of the vehicle and the lateral velocity of the vehicle. The vehicle movement parameters are the gradient of the underlying surface, the lateral inclination of the underlying surface and the coefficient of friction of the underlying surface.

Block 202 represents wheel speed sensors which are assigned to the wheels of the vehicle. The wheel speed parameters omegaij which are determined using the wheel speed sensors are supplied both to the sensor module 101 and to the processing means 102. The abbreviated notation omegaij has the following meaning: the index i indicates whether the wheel is a front wheel (v) or a rear wheel (h). The index j indicates whether it is a left-hand wheel (l) or a right-hand wheel (r).

Block 201 represents sensor means with which parameters which describe the steering angles set for the steerable wheels are determined. If the vehicle has front axle steering, the block 201 can be a sensor for sensing the steering wheel angle set by the driver. Depending on the requirement made of the accuracy to be achieved, this steering wheel angle can be respectively converted to a wheel-specific steering wheel angle for the two front wheels. As an alternative to this configuration of the steering wheel angle and conversion it is also possible to use sensors which are assigned specifically to the two front wheels to determine the wheel-specific wheel steering angle. A corresponding procedure can be adopted with a vehicle with front axle steering and rear axle steering, in which case, under certain circumstances, four sensors which are assigned to the individual wheels are necessary.

In FIG. 2, the designation delta is used in a simplified fashion for the parameters generated using the block 202, irrespective of whether the angle is the steering wheel angle or specific wheel steering angles. The parameters delta are thus supplied both to the sensor module 101 and to the processing means 102. In the preferred embodiment, a vehicle with front axle steering is assumed. Alternatively, it is also possible to consider a vehicle which has steered wheels both at the front axle and at the rear axle.

As already mentioned, the processing means 102 is a yaw rate controller, which is also known by the designation vehicle movement dynamics controller (VMD) or the abbreviation ESP (Electronic Stability Program). A yaw rate controller is used to stabilize the vehicle about its vertical axis. For this purpose, a setpoint value for the yaw rate of the vehicle is determined from the steering angle set by the driver or the wheel-specific wheel steering angles and the vehicle velocity which is determined. This setpoint value for the yaw rate is limited, as a function of the applicable coefficient of friction of the underlying surface, to a maximum value which can be implemented or driven given the applicable underlying surface conditions. This setpoint value is compared with the actual value for the yaw rate. During this comparison, the deviation of the actual value from the setpoint value is determined. Depending on this deviation, changes in the setpoint slip, with which the setpoint slip which is to be set at the respective wheel is modified, are determined for the individual vehicle wheels. At the same time, the attitude angle of the vehicle is limited or regulated. The attitude angle represents the angle between the longitudinal axis of the vehicle and the velocity vector. The attitude angle is determined as a function of the longitudinal velocity and the lateral velocity.

In order to set the modified setpoint slip values, braking interventions are carried out at the individual wheels of the vehicle independently of the driver, by actuating the brake actuators 203 which are respectively assigned to the vehicle wheels. The respective actual slip is approximated to the predefined setpoint slip for each individual wheel by means of these wheel-specific brake interventions by generating a braking torque. As a result, a yaw moment which acts on the vehicle is generated, said yaw moment causing the vehicle to rotate about its vertical axis, as a result of which the actual value of the yaw rate approaches the associated setpoint value. By actuating corresponding actuators 204 in a way which supports the wheel-specific brake interventions which are carried out independently of the driver, it is possible also to carry out engine interventions with which the engine torque which is output by the engine is reduced.

The steering wheel angle or the specific steering wheel angles are received by the yaw rate controller from the block 201. The parameters comprising the longitudinal velocity, lateral velocity, actual value for the yaw rate and coefficient of friction of the underlying surface are made available to the yaw rate controller 102 by the sensor module 101. In addition, the yaw rate controller can also be supplied with the lateral acceleration from the sensor module 101.

The parameter comprising the inclination of the underlying surface, which is supplied to the yaw rate controller 102 from the sensor module 101, is taken into account in order to detect and take into account journeys on steeply walled bends.

For the sake of clarity, further sensor means which are possibly necessary in the context of the yaw rate control which is carried out in block 102 have not been illustrated in FIG. 2. A sensor for sensing the admission pressure for the brakes which is set by the driver, and whose signal is fed to the block 102, possibly has to be taken into account.

As already mentioned, the block 102 for regulating the yaw rate of the vehicle actuates brake actuators 203 or means 204—assigned to the vehicle wheels—for influencing the engine torque which is output by the engine.

The brake actuators may be part of a hydraulic or electrohydraulic or pneumatic or electropneumatic or electromechanical brake system. In the first four brake systems mentioned, the brake actuators are valves which can be actuated and by means of which braking medium is supplied to a wheel brake cylinder or carried away from it. In the brake system mentioned last, the brake actuators are electrically actuated actuating motors whose actuation can generate a braking torque at the individual vehicle wheels.

The brake actuators are actuated by means of the signals EBx, which are supplied to the block 203 from the block 102. In a conventional hydraulic brake system, the signals EBx are the actuation signals with which the individual valves are actuated. In an electrohydraulic brake system, the signals EBx correspond to the setpoint brake pressures which are to be set for the individual wheels. These setpoint brake pressures are converted into actuation signals for the individual valves using a control device which is assigned to the electrohydraulic brake system. In a conventional hydraulic brake system, the brake actuators 203 do not provide feedback to the yaw rate controller 102 i.e., in this case no signals BEx are provided. In an electrohydraulic brake system, the status of the brake actuators 203 is fed back to the yaw rate controller 102 by means of the signals BEx.

If the brake system is an electrohydraulic one, the braking torques Mbr which are set at a particular time can optionally be supplied to the sensor module 101. If the brake system is a conventional hydraulic one, brake pressure parameters Pbr which represent the brake pressures set at the individual wheels and which are determined in the yaw rate controller 102 using a mathematical pressure estimation model can optionally be supplied to the sensor module 101. The optional supplying of the applicable parameters to the sensor module 101 in the two cases is indicated by the dashed representation in FIG. 2.

The block 204 is a unit for influencing the engine torque which is output by the engine. The engine torque which is to be output is set as function of the signals EMx which are supplied to the block 204 from the yaw rate controller 102 via what is referred to as an engine interface, and which predefine the engine torque which is to be set. The engine torque which is set at a particular time is fed back to the yaw rate controller 102 from the block 204 by means of the signals MEx. The means 204 may be, for example, a throttle valve or an injection device. The engine torque Mmot which is set at a particular time can optionally be supplied to the sensor module 101, which is indicated by the dashed representation in FIG. 2.

For the following reason, on the one hand the braking torques Mbr or the brake pressure parameters Pbr and, on the other hand, the engine torque Mmot are supplied to the sensor module: in the sensor module 101 a support calculation is carried out in conjunction with the determination of the second vehicle movement parameters and the underlying surface parameters. For this purpose, the torque equilibrium is evaluated in the longitudinal direction, for which purpose the parameters which are optionally supplied are required.

In addition to actuating the brake actuators 203 or the means 204 for influencing the engine torque which is output by the engine, it is also possible to provide for a transmission 205 to be actuated by the yaw rate controller. For this purpose, a signal EGx is supplied to the transmission 205 from the yaw rate controller 102, with which signal EGx the transmission is provided with information about whether the engaged gear velocity is to be maintained or whether a higher or a lower gear velocity is to be engaged. The transmission 205 provides the yaw rate controller 102 with feedback, by means of signals GEx, about the currently engaged gear or about the target gear which is to be engaged. It is optionally possible to provide for the transmission 205 to supply the sensor module 101 with information about the currently engaged gear velocity or about the currently implemented transmission ratio by means of the signals Gx. These parameters are required in the sensor module 101 in order to enable the engine torque which is output by the engine to be converted into a wheel torque which is present at the driven wheels.

Further processing means, such as for example an inter-vehicle distance controller or a device for influencing the behavior of the chassis, are not represented in FIG. 2 for the sake of clarity.

The sensor module 101 is supplied, from the yaw rate controller 102, with signals FE which communicate which controller of the yaw rate controller is active at a specific time, to the sensor module 101. The concept of yaw rate control provides a controller structure made up of subordinate controllers which are a brake slip controller and a traction controller, and a superordinate controller, referred to the as the vehicle controller, which controls the yaw rate of the vehicle. Consequently, the signals FE contain information as to whether the controller is the brake slip controller and/or traction controller and/or vehicle controller, and if so which of them is active. This information is taken into account during the determination of the underlying surface parameters and/or the second vehicle movement parameters as follows.

The average coefficient of friction of the underlying surface is determined using an estimation method. This estimation method supplies a reliable estimated value for the average coefficient of friction of the underlying surface if the longitudinal slip or lateral slip of at least one wheel of the vehicle lies in the vicinity of the adhesion limit. The reason for this is as follows: in the estimational method the maximum possible coefficient of friction of the underlying surface (the value 1), is usually selected as the starting value of the estimation. If the situation described above, during which a wheel of the vehicle is in the vicinity of the adhesion limit, then occurs, a first approximate item of information about the coefficient of friction of the underlying surface is already available in this situation. This value, which in any case describes the situation better than the value assumed as 1, can then be used as a starting value.

As a result, the estimation method, on which a Kalman filter is advantageously based, can more quickly determine the precise value of the coefficient of friction of the underlying surface which applies in this situation. This leads in turn to the situation in which the second vehicle movement parameters can be determined with greater accuracy since the estimated coefficient of friction of the underlying surface is also included in their determination.

The defined mode of operation of the sensor module will be described with reference to FIG. 3.

The sensor module 101 is composed of determining means 101a and computing means 101b. The determining means 101a are a sensor means for sensing the longitudinal acceleration of the vehicle, a sensor means for sensing the lateral acceleration of the vehicle, a sensor means for sensing the vertical acceleration of the vehicle and/or a sensor means for sensing the yaw rate of the vehicle. The sensor module can optionally also contain sensing means for sensing the rotational velocity of the vehicle about its longitudinal axis (referred to as the roll velocity), and/or the rotational velocity of the vehicle about its lateral axis (referred to as the pitch velocity).

The computing means 101b are a control device which is assigned exclusively to the sensor module. This control device communicates via a data bus, the data bus 107 illustrated in FIG. 1, with other control devices arranged in the vehicle, which are the processing means 102, 103, 104, 105 and 106 represented in FIG. 1.

Second vehicle movement parameters and/or underlying surface parameters are determined using the computing means 101b at least as a function of the parameters which are sensed using the sensor means specified above, which are the longitudinal acceleration and/or lateral acceleration and/or vertical acceleration and/or yaw rate. In addition to these parameters specified above, further parameters, which are sensed using sensor means which are not arranged in the sensor module 101, are taken into account during the determination of the second vehicle movement parameters and/or the underlying surface parameters. These parameters are the steering wheel angle or the specific steering wheel angles delta, which are supplied to the sensor module 101 from the block 201, and/or the wheel speeds omegaij, which are supplied to the sensor module 101 from the block 202.

Further parameters can optionally be taken into account using sensor means, which are not located in the sensor module 101, during the determination of the second vehicle movement parameters and/or the underlying surface parameters. These parameters may be the actual brake pressure and/or the spring compression travel values which are present at the individual wheels and which are made available by a device for influencing the behavior of the chassis.

The actual brake pressure is required for the supporting calculation which is carried out in conjunction with the determination of the second vehicle movement parameters and the underlying surface parameters. The spring compression travel values are required in order to be able to eliminate the influence of the vehicle's own movement from the vehicle longitudinal acceleration parameter, from the vehicle lateral acceleration parameter and/or from the vehicle vertical acceleration parameter.

The second vehicle movement parameters Sx2 which are determined in the sensor module 101 and which are the longitudinal velocity of the vehicle and/or the lateral velocity of the vehicle, are supplied to the block 102 for further processing. The underlying surface parameters Fg, which are also determined in the sensor module 101 (the gradient and/or lateral inclination of the underlying surface, and/or the coefficient of friction of the underlying surface) are also fed to the block 102 for further processing.

The first vehicle movement parameters Sx1, which are sensed using sensing means 101a contained in the sensor module 101 (the longitudinal acceleration, the lateral acceleration, the vertical acceleration and/or the yaw rate) are also supplied to block 102. Where necessary, the individual parameters which are associated with the first vehicle movement parameters Sx1 can, before being fed to the block 102, be, for example, filtered in the sensor module 101 or subjected to a transformation during which these individual parameters are matched onto the center of gravity of the vehicle.

Freewheeling wheel speeds or values for the steering wheel angle or the wheel steering angles which are compensated or offset can also optionally be determined. In order to determine the freewheeling wheel speeds it is appropriate, for example, to transform the vehicle velocity which has been determined for the center of gravity of the vehicle to the geometric locations of the vehicle wheels taking into account the vehicle movement and the geometry of the vehicle. The values which are compensated or offset may be determined, for example, by means of a long term filtering operation. Sensor means for sensing a parameter which describes the rotational movement of the vehicle about its longitudinal axis and/or sensor means for sensing a parameter which describes the rotational movement of the vehicle about its lateral axis may optionally also be provided in the sensor module 101. It is also conceivable for parameters which correspond to the derivative of the yaw rate over time (the rotational velocity of the vehicle about its vertical axis, the derivative of the rotational velocity over time with respect to the longitudinal axis or the derivative of the rotational velocity over time with respect to the lateral axis of the vehicle) to be determined in the sensor module. All these parameters may be output in the form of the signals Sx3 by the sensor module 101 and made available to various processing means which are combined to form a block 301. Of course, these signals Sx3 can also be supplied to the block 102.

In FIG. 3, for reasons of clarity, the parameters omegaij and delta have not been supplied to the block 102 as is illustrated in FIG. 2.

The second vehicle movement parameters Sx2 and/or the underlying surface parameters Fg are determined in the sensor module 101 in accordance with the following method steps: First, signal conditioning is carried out both for the sensor signals sensed using the sensing means 101a arranged in the sensor module 101 and for the sensor signals which are supplied to the sensor module 101 from external sensor means. Within the scope of the signal conditioning, the sensor signals are monitored with reference to model-supported plausibilities and/or on the basis of a redundant configuration of the sensing means or sensor means. Likewise, the offset of the sensor signals can be corrected using long term filtering. For the longitudinal acceleration, lateral acceleration and/or vertical acceleration, on the one hand transformation to the center of gravity of the vehicle and on the other hand pitch correction and/or roll correction are performed. The transformation to the center of gravity of the vehicle is necessary since the sensor module 101 is installed at any desired location on the vehicle and thus measures at this location, but parameters which are referred to the center of gravity are required for the processing in the processing means.

The pitch correction and/or roll correction are either carried out in a model-supported fashion or by means of an evaluation of spring travel sensors. Using this correction, the actual movement of the bodywork of the vehicle is eliminated from the measurement parameters. In addition, all the sensor signals are low-pass filtered in order to eliminate interference.

The longitudinal, lateral and/or vertical acceleration and/or yaw rate which are conditioned using the signal conditioning means are output as first vehicle movement parameters.

In a subsequent method step, wheel load calculation is carried out; i.e., the normal forces acting at the individual wheels are determined. This calculation is carried out as a function of the signal-conditioned longitudinal, lateral and/or vertical acceleration, and of geometry data describing the position of the center of gravity, and of data which describes characteristic parameters—relevant to the calculation—of the axles, suspension systems and/or damping systems which are installed in the vehicle. The normal forces which act on the individual wheels are required since the estimation method with which the second vehicle movement parameters and/or the underlying surface parameters are determined operates on the basis of parameters which are standardized to the normal force.

By taking into account the geometry of the vehicle, the normal forces acting at the individual wheel contact points are obtained from the sensed vertical acceleration. Owing to the longitudinal and lateral acceleration, information is available about the movement of the vehicle on the flat. This movement of the vehicle itself can thus be taken into account during the determination of the normal forces and thus eliminated.

In a further step, the second vehicle movement parameters and/or the underlying surface parameters are determined using a suitable state observer. The longitudinal, lateral and/or vertical acceleration, the yaw rate, yaw acceleration, wheel speeds and/or the steering wheel angle or the wheel-specific wheel steering angles, both transformed and corrected for pitch and roll, are used as the input parameters for the state observer. The state observer determines the longitudinal and/or lateral velocity of the vehicle, and/or the lateral inclination, gradient or coefficient of friction of the underlying surface, using a suitable estimation method, the state observer (for example, a Kalman filter). Within the scope of the invention of the parameters mentioned above, sensor signals which are filtered to an optimum degree are determined using the state observer. These signals may be made available, if necessary, to the processing means, arranged in the vehicle, for further processing. In addition to the parameters specified above, the state observer can also determine freewheeling wheel speeds, which can then also be made available.

In a further method step, special traveling situations can be detected. For example, the risk of rolling over can be detected in a model-supported fashion by evaluating the longitudinal, lateral and/or vertical acceleration which has been both transformed and corrected for pitch and roll. If this parameter is available, the angular velocity can also be evaluated with respect to the longitudinal axis of the vehicle. Alternatively, the risk can also be detected by means of a combined evaluation of the spring travel sensor system and the angular velocity with respect to the longitudinal axis of the vehicle. The risk of rolling over is present, for example, if, when cornering, the wheels on the inside of the bend are subject to spring extension to a large degree and the wheels on the outside of the bend are subject to spring compression to a large degree and at the same time the angular velocity with respect to the longitudinal axis is greater than a predefined threshold value.

A further special situation which may be detected is the swaying of the vehicle such as occurs with a swaying trailer. For this purpose, a parameter which describes the lateral dynamics of the vehicle is evaluated. If the parameter which describes the lateral dynamics of the vehicle exhibits an essentially periodic behavior, the vehicle is swaying.

In addition, a stationary state of the vehicle can be detected. For this purpose, the sensor signals which are determined using the wheel speed sensors, the longitudinal, lateral and/or vertical acceleration and/or the yaw rate can be determined using plausibility interrogation. If present, the angular velocity with respect to the longitudinal axis and/or the angular velocity with respect to the lateral axis can also be evaluated. Alternatively or additionally it is also appropriate to evaluate the actual brake pressures. If these are larger than a predefined threshold value, it is possible to assume that a stationary state of the vehicle is present. A further special traveling situation which can be detected is also the driving direction. For this purpose, the wheel steering angles, the yaw rate and the sensor signals of the wheel velocity sensors which contain information about the rotational velocity of the wheel are evaluated using plausibility interrogation.

In a further method step it is possible to condition position information. For this purpose “horizontalized” signals (signals which are referred to the underlying surface), are necessary. In this method step it is possible to make available, for example, information about the distance covered starting from a starting point and/or information about the actual coordinates of the vehicle referred to a starting point and/or information about the orientation of the vehicle, also referred to a starting point.

The state observer is supplied with signal-conditioned sensor signals. The signal-conditioned sensor signals and the signals which are determined by the state observer are evaluated both during the detection of the special traveling situations and during the conditioning of position information.

The parameters which are described above and which are to be assigned neither to the first vehicle movement parameters nor to the second vehicle movement parameters nor to the underlying surface parameters are contained in the signals Sx3.

To summarize, the device according to the invention relates to a sensor module having an evaluation unit and containing, as a sensor fusion, a plurality of sensing means and being advantageously mounted at a central location on the vehicle.

The device according to the invention that is, the sensor module, provides a high potential saving with respect to the sensor system which is installed in a vehicle since it avoids the installation of multiple identical sensors. At the same time, the signal quality is improved since the cost savings can be invested in higher quality sensors. The device according to the invention makes it possible to determine parameters which cannot be measured directly, or can only be measured at high cost, such as for example, the attitude angle, gradient, inclination, and/or coefficient of friction of the underlying surface, in a centralized fashion using algorithms, and to make them generally available.

A number of properties of the sensor module according to the invention are specified below:

The sensor module is a unit which is installed centrally in the vehicle and which is composed of at least one measuring device and one computing unit, the computing unit carrying out signal manipulations. Alternatively or additionally, the computing unit also monitors the signals. The computing unit can be used to calculate signals which cannot be measured directly or are not measured directly from the signals which are measured directly.

The device according to the invention is a unit which is installed centrally in the vehicle and in which at least measuring devices for the parameters comprising the longitudinal acceleration, lateral acceleration and yaw velocity as well as a computing unit are combined. The computing unit calculates at least one of the parameters comprising the longitudinal and lateral velocity of the vehicle, as well as the gradient, inclination and coefficient friction of the underlying surface, from these signals taking into account the wheel speeds and the steering wheel angle.

Alternatively, the device according to the invention is a unit which is installed centrally in the vehicle and in which at least measuring devices for the parameters comprising the longitudinal acceleration, lateral acceleration, vertical acceleration and yaw velocity as well as a computing unit are combined. The computing unit calculates at least one of the parameters comprising the longitudinal velocity, lateral velocity, gradient of the underlying surface, lateral inclination of the underlying surface and coefficient of friction of the underlying surface from these signals taking into account the wheel speeds and the wheel-specific steering angles of the vehicle wheels.

The device according to the invention permits existing systems for regulating and/or controlling a parameter which describes and/or influences of the movement of a vehicle to be improved. Examples of such systems specified at this point are an inter-vehicle distance controller, a yaw rate controller or a system for influencing the behavior of the chassis.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. A device for making available parameters that are used to adjust or control a parameter that describes or influences movement of a vehicle, the parameters which are made available being vehicle movement parameters which describe the movement of the vehicle, and underlying surface parameters which describe the quality or course of an underlying surface, said device comprising:
sensing means for sensing first vehicle movement parameters; and
computing means for determining second vehicle movement parameters and underlying surface parameters, at least as a function of the first vehicle movement parameters; wherein,
the first and second vehicle movement parameters are different physical parameters;
the sensing means and the computing means are spatially combined to form a single physical unit; and
the first vehicle movement parameters, the second vehicle movement parameters, and underlying surface parameters are made available to processing means arranged in the vehicle outside the single physical unit, for further processing,

12. The device as claimed in claim 11, wherein the processing means are regulation or control means for influencing a movement parameter which describes or influences movement of the vehicle.

13. The device as claimed in claim 11, wherein said processing means comprises one of a yaw rate controller, a device which influences behavior of the chassis, an inter-vehicle distance controller which sets a distance from the vehicle traveling in front using interventions in the brakes or in the engine, an engine controller, a transmission controller, a brake slip controller and a traction controller.

14. The device as claimed in claim 11, wherein the processing means comprises a component of a device with which a parameter that describes or influences movement of the vehicle is influenced, by means of input signaling processing of such a device.

15. The device as claimed in claim 11, wherein the sensing means senses a parameter which describes at least one of lateral acceleration of the vehicle, longitudinal acceleration of the vehicle, vertical acceleration of the vehicle, rotational velocity of the vehicle about its vertical axis, and rotational velocity of the vehicle about its longitudinal axis, and a rotational velocity of the vehicle about its lateral axis, as a first vehicle movement parameter.

16. The device as claimed in claim 11, wherein the computing means determines, at least one parameter which describes one of the longitudinal velocity of the vehicle and the lateral velocity of the vehicle, as a second vehicle movement parameter.

17. The device as claimed in claim 11, wherein the computing means determines at least one parameter which describes one of a gradient of the underlying surface, lateral inclination of the underlying surface, and a coefficient of friction of the underlying surface, as an underlying surface parameter.

18. The device as claimed in claim 11, wherein, in addition to the first vehicle movement parameter, at least one of the following parameters is taken into account in determining the second vehicle movement parameters or the underlying surface parameters: wheel velocity, a parameter which describes steering wheel angle, parameters which describe wheel-specific steering angles of vehicles wheels, spring compression travel parameters and brake pressure parameters.

19. The device as claimed in claim 11, wherein:
the processing means make available parameters which contain information regarding at least one of
whether the respective processing means is active;
if the processing means has a structure divided into superordinate and subordinate controllers, which of the subordinate controllers is active; and
the operating state of actuators assigned to the processing means; and
these parameters are taken into account at least in determining at least one of the second vehicle movement parameters and the underlying surface parameters.
